(19) United States
(12) Patent Application Publication
(10) Pub. No.: US 2003/0080985 A1
(43) Pub. Date: May 1, 2003

(54) Method of adjusting image, and image display system, image display device and image data generation device

(76) Inventors: Shuichi Kagawa, Tokyo (JP); Hiroaki Sugiura, Tokyo (JP); Hideyuki Kaneko, Tokyo (JP)

Correspondence Address: BIRCH STEWART KOLASCH & BIRCH, PO BOX 747, FALLS CHURCH, VA, 22040-0747, US

(21) Appl. No.: 10/124,340

(22) Filed: Apr. 18, 2002

(30) Foreign Application Priority Data
Oct. 26, 2001 (JP) P2001-329060

(51) Int. Cl. G09G 5/02

(52) U.S. Cl. 345/698

(57) ABSTRACT

When a user instructs an image display device (1b) to perform an automatic level adjustment, the image display device (1b) transmits the instruction to an image data generation device (2b). Then, the image data generation device (2b) sends adjusting-image data generated by an adjusting-image data generator (11) to the image display device (1b). When the adjusting-image data is completely sent out, the image data generation device (2b) notifies the image display device (1b) of completion of data sending. When the image display device (1b) is notified that the adjusting-image data is completely sent out, an automatic level adjuster (6b) performs the automatic level adjustment. At this time, the automatic level adjustment is performed on the basis of the adjusting-image data. Thus, an image display system consisting of the image data generation device and the image display device achieves an easy automatic image adjustment using image data suitable for the image adjustment.

### BACKGROUND OF THE INVENTION

1. Field of the Invention

The present invention relates to an image display system consisting of an image data generation device for outputting image data and an image display device for displaying an image on the basis of image data, and more particularly to a technique for effectively performing an automatic adjustment of luminance levels in the image display device.

2. Description of the Background Art

To image display devices such as liquid crystal display, generally, various kinds of image data generation devices are connected through transmission lines. For example, a personal computer (PC) and the like are used as the image data generation device and a video cable and the like are used as the transmission line.

The image data generation devices such as a PC each have various image data output characteristics. In other words, the characteristics in format, signal level and the like of the image data to be inputted to the image display device depend on the image data output characteristics belonging to the image data generation device which outputs the image data. Therefore, in order for the image display device to always achieve excellent image displays, it is necessary to perform an image adjustment in accordance with the image data generation device connected to the image display device through a transmission line. In particular, an automatic image adjustment requiring no complicated operation is an important technique for a user.

Now, discussion will be made on an outline of automatic image adjustment in the background art. FIG. 10 is a block diagram for explanation of an image adjusting method used in an image display system of the background art. This figure shows an image display device 1a, an image data generation device 2a and a transmission means 3a. Further, the image display device 1a has a display unit 4, an A/D converter 5 and an automatic level adjuster 6a. The image data generation device 2a has an image data sender 7a and an image data generator 8.

The image data generator 8 generates image data to be displayed on the display unit 4 of the image display device 1a and outputs the image data to the image data sender 7a. The image data sender 7a sends out the image data outputted from the image data generator 8 as image data of analog signals (analog image data) to the transmission means 3a. The image data generated by the image data generator 8 depends on the state of use by a user at that time. For example, when the image data generation device 2a is a PC, the image data generated by the image data generator 8 is a screen image of an operating system, that of an application software or the like, depending on the state of use by the user at that time.

To the image display device 1a inputted is the analog image data outputted from the image data generation device 2a through the transmission means 3a. The analog image data inputted to the image display device 1a is quantized into image data of digital signals (digital image data), with reference to a reference voltage in the A/D converter 5. The digital image data is inputted to the display unit 4 and displayed as an image.

The automatic level adjuster 6a performs an automatic adjustment in luminance level (automatic level adjustment) of the display image by adjusting the minimum level and the maximum level in quantization of the analog image data. Assuming that the digital image data is 8-bit digital data of integers having the minimum value of 0 and the maximum value of 255, the minimum level refers to a signal level (voltage) of the analog image data which is quantized into the digital image data of 0 and the maximum level refers to a signal level (voltage) of the analog image data which is quantized into the digital image data of 255. Specifically, a minimum level adjustment is to adjust the signal level of the analog image data which is quantized into the digital image data of 0 to an appropriate value and a maximum level adjustment is to adjust the signal level of the analog image data which is quantized into the digital image data of 255 to an appropriate value.

Possible methods for the maximum level adjustment and the minimum level adjustment are an adjustment of reference voltage value used in the A/D converter 5, application of an appropriate offset voltage to the analog image data, and the like.

Further, the automatic level adjustment is performed at a timing that the user gives an instruction to perform the automatic level adjustment by means of e.g., an on-screen menu in the image display device or at a predetermined timing which is set in advance.

Without such appropriate maximum level adjustment and minimum level adjustment performed by the automatic level adjuster 6a, an image displayed on the display unit 4 is of low quality. For example, when the maximum level is too low for the maximum value of the inputted analog image data, the image displayed on the display unit 4 has poor tone reproduction in a portion of high luminance, and when the minimum level is too high for the minimum value of the inputted analog image data, the image displayed on the display unit 4 has poor tone reproduction in a portion of low luminance.

Conversely, when the maximum level is too high for the maximum value of the inputted analog image data or the minimum level is too low for the minimum value of the inputted analog image data, the image displayed on the display unit 4 has poor contrast. Further, a phenomenon that an increased effect of quantization error makes it impossible to achieve a desirable tone reproduction, i.e., a so-called tone dropout occurs.

Now, an operation of the automatic level adjuster 6a will be discussed in more detail. The automatic level adjuster 6a monitors the digital image data and counts the number of occurrences of the maximum possible value of the digital image data (maximum data) and the number of occurrences of the minimum possible value of the digital image data (minimum data) within a predetermined period. Specifically, assuming that the digital image data is 8-bit digital data like the above example, the minimum data is 0 and the maximum data is 255, and the automatic level adjuster 6a counts the number of occurrences of these data. When the number of occurrences of the maximum data is less than a predetermined value, the automatic level adjuster 6a judges that the maximum level is too high and controls the A/D converter 5 to reduce the maximum level. On the other hand, when the number of occurrences of the maximum data is more than a predetermined value, the automatic level adjuster 6a judges that the maximum level is too low and controls the A/D converter 5 to enhance the maximum level. Further, when the number of occurrences of the minimum data is less than a predetermined value, the automatic level adjuster 6a judges that the minimum level is too low and controls the A/D converter 5 to enhance the minimum level and when the number of occurrences of the minimum data is more than a predetermined value, the automatic level adjuster 6a judges that the minimum level is too high and controls the A/D converter 5 to reduce the minimum level.

Thus, since the automatic level adjustment is performed in the image display device 1 a with reference to the image data inputted from the image data generation device 2a, it is possible to achieve an adjustment in accordance with the image data generation device 2a connected to the image display device 1a.

As discussed above, the image data used for the automatic level adjustment in the background-art image display device 1a is the image data inputted from the image data generation device 2a. The image data outputted from the image data generation device 2a, however, depends on the state of use of the image data generation device 2a at that time and is not necessarily suitable for the automatic level adjustment.

For example, it is assumed, in the image data generation device 2a, that the image data generator 8 generates the digital image data taking an integer ranging from 0 to 255 and the image data sender 7a converts the digital image data into the analog image data represented by a voltage ranging from 0.5 V to 1.5 V and outputs the analog image data. The analog image data is inputted to the image display device 1a through the transmission means 3 and converted into the digital image data through quantization in the A/D converter 5. In this case, it is desirable to perform such an automatic level adjustment as to convert the analog image data of 0.5 V into the digital image data of 0 and the analog image data of 1.5 V into the digital image data of 255.

In the automatic level adjustment performed by the background-art image display device 1a, however, the digital image data generated by the image data generator 8 in the image data generation device 2a depends on the state of use of the image data generation device 2a at that time and does not necessarily include all the data ranging from 0 to 255. In other words, the analog image data inputted to the image display device 1a does not necessarily have a range from 0.5 V to 1.5 V.

Considering a case where an automatic level adjustment is performed under a condition that the user selects an image including only mid-tone data, e.g., an image whose analog image data ranges from 0.8 V to 1.2 V, the automatic level adjuster 6a performs such an automatic level adjustment as to quantize the analog image data of 0.8 V into the digital image data of 0 and the analog image data of 1.2 V into the digital image data of 255. As a result, all the analog image data of 0.8 V or lower are quantized into 0 and all the analog image data of 1.2 V or higher are quantized into 255, and the image displayed on the display unit 4 has poor tone reproduction in high luminance portions and low luminance portions.

In short, in order to appropriately perform the automatic image adjustment such as the automatic level adjustment in the image display device 1a, it is necessary to perform the image adjustment with an image suitable therefor. In the background-art image display system, however, the image data outputted from the image data generation device 2a depends on the state of use by the user. That requires the user, at a timing of automatic image adjustment, to prompt output of an image suitable for the adjustment. For this, the user needs to fully understand the operation of the automatic image adjustment such as the automatic level adjustment to be performed and select an image suitable for the adjustment to perform the automatic image adjustment.

Though image display systems consisting of image data generation devices such as PCs and the image display devices such as liquid crystal displays have been widespread in recent, few users have full knowledge on the operation of the automatic image adjustment. It is much difficult for the user having little knowledge on the operation of the automatic image adjustment to select an image suitable for the adjustment to be performed and perform the automatic image adjustment.

As discussed above, the automatic image adjustment using an image not suitable for the image adjustment to be performed has high probability of deteriorating the quality of image displayed on the image display device and results in confusion of the user.

### SUMMARY OF THE INVENTION

An object of the present invention is to provide an image display system consisting of an image data generation device and an image display device, which allows an easy automatic image adjustment using image data suitable therefor, and a method of automatically adjusting an image, which is performed in the image display system.

According to a first aspect of the present invention, an image display system includes an image data generation device for outputting image data and an image display device for displaying an image on the basis of the image data.

The image display device includes an automatic image adjuster for performing an automatic adjustment of a display image on the basis of the image data. The image data generation device includes adjusting-image data output means for outputting adjusting-image data used for the automatic adjustment as the image data, and adjusting-image data output completion notifying means for outputting an output completion signal used for notifying completion of output of the adjusting-image data from the adjusting-image data output means. The automatic image adjuster receives the output completion signal and performs the automatic adjustment when notified of the completion of output of the adjusting-image data.

In the image display system of the present invention, the automatic adjustment in the image display device is always performed using the adjusting-image data suitable for the automatic adjustment. Therefore, it is possible to avoid the problem in the background-art image display system that an automatic image adjustment using an image not suitable therefor results in deterioration in quality of image.

Further, an user has only to instruct the image data generation device to perform the automatic adjustment and therefore can easily achieve an appropriate level adjustment without any knowledge on the details of the automatic image adjustment to be performed.

According to a second aspect of the present invention, a method of adjusting an image, which is used in an image display system including an image data generation device for outputting image data and an image display device for displaying an image on the basis of the image data and performing an automatic adjustment of a display image on the basis of the image data includes the following steps of (a) to (c).

The step (a) is performed for outputting adjusting-image data used for the automatic adjustment as the image data from the image data generation device to the image display device. The step (b) is performed for outputting an output completion signal used for notifying completion of output of the adjusting-image data from the image data generation device to the image display device. The step (c) is performed for performing the automatic adjustment in the image display device when the image display device is notified of the completion of output of the adjusting-image data in the step (b).

In the method of adjusting an image of the present invention, the automatic adjustment in the image display device is always performed using the adjusting-image data suitable therefor. Therefore, it is possible to avoid the problem in the background-art image display system that an automatic image adjustment using an image not suitable therefor results in deterioration in quality of image.

According to a third aspect of the present invention, an image data generation device for outputting image data includes adjusting-image data output means and adjusting-image data output completion notifying means.

The adjusting-image data output means outputs adjusting-image data used for an automatic adjustment of a display image as the image data. The adjusting-image data output completion notifying means outputs an output completion signal used for notifying completion of output of the adjusting-image data from the adjusting-image data output means.

In the image data generation device of the present invention, an automatic adjustment can be achieved using the adjusting-image data suitable therefor if, for example, the automatic adjustment in the externally-connected image display device is performed on the basis of the output completion signal.

According to a fourth aspect of the present invention, an image data generation device for outputting image data includes adjusting-image data output means.

The adjusting-image data output means outputs adjusting-image data used for an automatic adjustment of a display image as the image data on the basis of a signal which is externally inputted.

In the image data generation device of the present invention, it is possible to control the timing of outputting the adjusting-image data by an externally-connected device and the like. For example, by outputting the adjusting-image data at the timing of starting the automatic adjustment in the externally-connected image display device, the automatic adjustment can be performed using the adjusting-image data suitable therefor.

According to a fifth aspect of the present invention, an image display device for displaying an image on the basis of image data includes automatic image adjuster for performing an automatic adjustment of a display image on the basis of the image data.

The automatic image adjuster performs the automatic adjustment on the basis of a signal which is externally inputted.

In the image display device of the present invention, it is possible to control the timing of outputting the adjusting-image data by an externally-connected device. For example, by performing the automatic adjustment at the timing of outputting the adjusting-image data suitable therefor from the externally-connected image data generation device, the automatic adjustment can be performed using the adjusting-image data suitable therefor.

According to a sixth aspect of the present invention, an image display device for displaying an image on the basis of image data includes automatic image adjuster and automatic-adjustment start notifying means.

The automatic image adjuster performs an automatic adjustment of a display image on the basis of the image data. The automatic-adjustment start notifying means outputs an adjustment start signal used for notifying a start of the automatic adjustment which is performed by the automatic image adjuster.

In the image display device of the present invention, it is possible to notify externally-connected devices and the like of the timing of the automatic adjustment. For example, if the externally-connected image data generation device outputs the adjusting-image data suitable for the image adjustment at a timing of starting the image adjustment on the basis of the adjustment start signal, the automatic adjustment can be performed using the adjusting-image data suitable therefor.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an exemplary constitution of an image display system in accordance with a first preferred embodiment of the present invention;

FIG. 2 is a view illustrating an operation for automatic level adjustment in the image display system in accordance with the first preferred embodiment of the present invention;

FIGS. 3 and 4 are views illustrating adjusting-image data used for automatic level adjustment in the image display system in accordance with the first preferred embodiment of the present invention;

FIG. 5 is a block diagram showing an exemplary constitution of an image display system in accordance with a second preferred embodiment of the present invention;

FIG. 6 is a view illustrating an operation for automatic level adjustment in the image display system in accordance with the second preferred embodiment of the present invention;

FIG. 7 is a block diagram showing an exemplary constitution of an image display system in accordance with a third preferred embodiment of the present invention;

FIG. 8 is a view showing an exemplary image under adjustment in the image display system in accordance with the third preferred embodiment of the present invention;

FIG. 9 is a block diagram showing an exemplary constitution of an image display system in accordance with a fourth preferred embodiment of the present invention; and

FIG. 10 is a block diagram for explanation of an image adjusting method used in an image display system of the background art.

### DESCRIPTION OF THE PREFERRED EMBODIMENTS

>The First Preferred Embodiment>

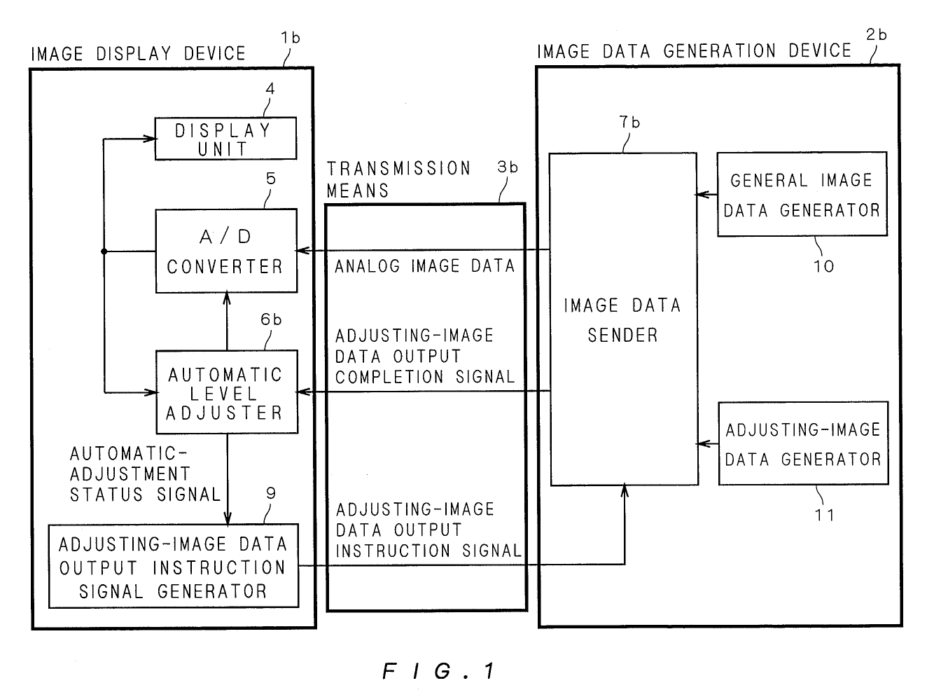

FIG. 1 is a block diagram showing an exemplary constitution of an image display system in accordance with the first preferred embodiment of the present invention. This figure shows an image display device 1b, an image data generation device 2b and transmission means 3b. Further, the image display device 1b has the display unit 4, the A/D converter 5, an automatic level adjuster 6b and an adjusting-image data output instruction signal generator 9. The image data generation device 2b has an image data sender 7b, a general image data generator 10 and an adjusting-image data generator 11.

The transmission means 3b is used for data transmission between the image display device 1b and the image data generation device 2b. As an example of the transmission means 3b, an analog video cable having a connector shape of D-sub15pin and the like may be used, for example, when the image data generation device 2b is a PC.

It is assumed, in the first preferred embodiment, that an automatic level adjustment is performed in the image display device 1b at a timing that a user gives an instruction to perform the automatic level adjustment by means of e.g., an on-screen menu in the image display device 1b.

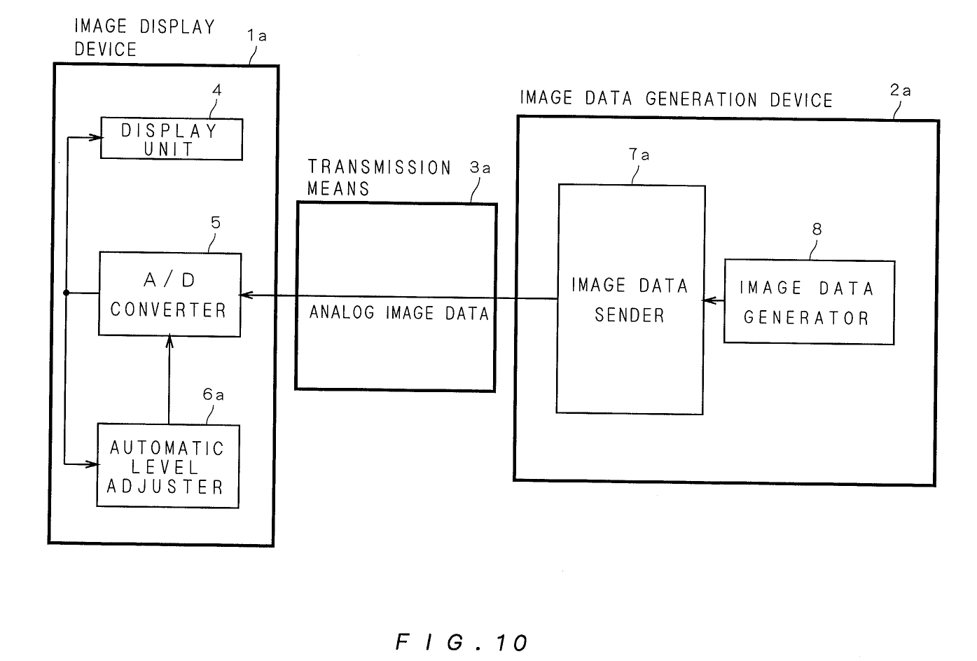

The general image data generator 10 in the image data generation device 2b generates image data in a state of normal use (referred to as “general image data”), like the image data generator 8 in the image data generation device 2a shown in FIG. 10. As the general image data, a screen image of an operating system, that of an application software or the like may be used, for example, when the image data generation device 2b is a PC. The generated general image data is outputted to the image data sender 7b.

On the other hand, the adjusting-image data generator 11 generates image data used for an image adjustment in the automatic level adjustment (referred to as “adjusting-image data”) and outputs the adjusting-image data to the image data sender 7b.

The image data sender 7b sends either the general image data or the adjusting-image data as the analog image data to the transmission means 3b on the basis of the content of a signal (adjusting-image data output instruction signal) from the adjusting-image data output instruction signal generator 9 in the image display device 1b. Further, the image data sender 7b outputs an adjusting-image data output completion signal used for notifying whether an operation of outputting the adjusting-image data is completed or not, to the transmission means 3b. The content of the adjusting-image data output completion signal is controlled to be “OK” when the output operation of the adjusting-image data is completed and otherwise “NG”.

The automatic level adjuster 6b outputs an automatic-adjustment status signal notifying an operating state of the automatic level adjuster 6b on the basis of the instruction from the user. The content of the automatic-adjustment status signal is controlled to be “Execution” when the automatic level adjuster 6b performs the automatic level adjustment and otherwise “Standby”. Further, in performing the automatic level adjustment, the automatic level adjuster 6b controls the A/D converter 5 to perform the automatic level adjustment when the adjusting-image data output completion signal from the image data sender 7b indicates “OK”. In the first preferred embodiment, the operation of the automatic level adjuster 6b to perform the automatic level adjustment is the same as that of the automatic level adjuster 6a shown in FIG. 10 and detailed discussion will be omitted.

The adjusting-image data output instruction signal generator 9 sends the adjusting-image data output instruction signal to the image data sender 7b on the basis of the automatic-adjustment status signal from the automatic level adjuster 6b. Specifically, the adjusting-image data output instruction signal generator 9 outputs the adjusting-image data output instruction signal of “OFF” when the automatic-adjustment status signal from the automatic level adjuster 6b is “Standby” and outputs the adjusting-image data output instruction signal of “ON” when automatic-adjustment status signal is “Execution”. Further, the image data sender 7b sends the general image data to the transmission means 3b when the adjusting-image data output instruction signal is “OFF” and it sends the adjusting-image data thereto when “ON”.

An operation of the image display system of the first preferred embodiment will be discussed below.

First, an operation in a state of normal use will be discussed. In the state of normal use, the automatic level adjuster 6b is in a standby state, not performing the automatic level adjustment, and the automatic-adjustment status signal indicates “Standby”. This automatic-adjustment status signal is inputted to the adjusting-image data output instruction signal generator 9.

The adjusting-image data output instruction signal generator 9 sends the adjusting-image data output instruction signal of “OFF” to the transmission means 3b since the automatic-adjustment status signal indicates “Standby”. The adjusting-image data output instruction signal is transmitted to the image data generation device 2b through the transmission means 3b and inputted to the image data sender 7b.

The image data sender 7b sends the general image data which is generated by the general image data generator 10 to the transmission means 3b as the analog image data since the adjusting-image data output instruction signal indicates “OFF”. At this time, since the adjusting-image data is not transmitted, the adjusting-image data output completion signal indicates “NG”.

The general image data outputted from the image data sender 7b is transmitted through the transmission means 3b and quantized into image data of digital signals (digital image data) in the A/D converter 5 of the image display device 1b with reference to the reference voltage. The digital image data is inputted to the display unit 4 and displayed as an image.

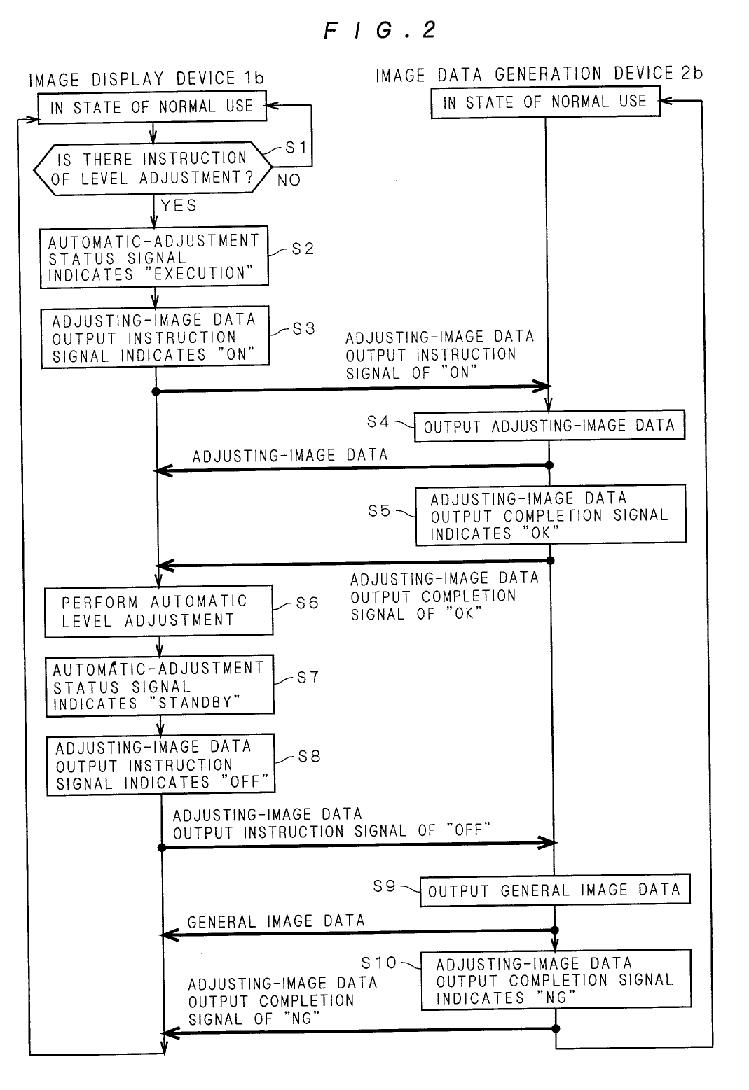

Next, an operation for performing the automatic level adjustment will be discussed. FIG. 2 is a view illustrating the operation for performing the automatic level adjustment by the image display system in accordance with the first preferred embodiment of the present invention. Discussion will be made below, referring to FIGS. 1 and 2.

First, when the user instructs to perform the automatic level adjustment (S1), the automatic level adjuster 6b changes the content of the automatic-adjustment status signal from “Standby” to “Execution” (S2). This automatic-adjustment status signal is inputted to the adjusting-image data output instruction signal generator 9.

The adjusting-image data output instruction signal generator 9 sends the adjusting-image data output instruction signal indicating “ON” to the transmission means 3b since the automatic-adjustment status signal indicates “Execution” (S3). The adjusting-image data output instruction signal is transmitted to the image data generation device 2b through the transmission means 3b and inputted to the image data sender 7b.

The image data sender 7b sends the adjusting-image data which is generated by the adjusting-image data generator 11 to the transmission means 3b as the analog image data since the adjusting-image data output instruction signal indicates “ON” (S4). Further, when the adjusting-image data is completely sent out, the image data sender 7b sends the adjusting-image data output completion signal indicating “OK” to the transmission means 3b (S5).

The automatic level adjuster 6b, receiving the adjusting-image data output completion signal of “OK”, controls the AID converter 5 to start the automatic level adjustment (S6). The automatic level adjustment is performed on the basis of the analog image data inputted in the A/D converter 5, and at this time, the adjusting-image data outputted from the image data sender 7b is inputted in the A/D converter 5. In other words, in the image display system of the first preferred embodiment, the automatic level adjustment is performed on the basis of the adjusting-image data. Therefore, if the adjusting-image data is suitable for the automatic level adjustment, it is possible to always easily perform the automatic image adjustment with suitable image data and easily improve the quality of image on the display unit 4.

Then, when the level adjustment of the digital image data is completed, the automatic level adjuster 6b changes the content of the automatic-adjustment status signal to “Standby” (S7). The adjusting-image data output instruction signal outputted from the adjusting-image data output instruction signal generator 9 thereby becomes “OFF” (S8).

Further, the image data sender 7b, receiving the adjusting-image data output instruction signal of “OFF”, outputs the general image data generated by the general image data generator 10 as the analog image data (S9). Furthermore, when the general image data is completely sent out, the image data sender 7b outputs the adjusting-image data output completion signal indicating “NG” (S10). In other words, both the image display device 1b and the image data generation device 2b return to the state of normal use.

As discussed above, the automatic level adjustment is performed by the automatic level adjuster 6b on the basis of the analog image data inputted in the A/D converter 5, and if the analog image data is not suitable for the automatic level adjustment, the automatic level adjustment has a probability of deteriorating the quality of image. In the first preferred embodiment, since the automatic level adjustment is performed on the basis of the adjusting-image data generated by the adjusting-image data generator 11, if the adjusting-image data is suitable for the automatic level adjustment, it is possible to easily improve the quality of image on the display unit 4.

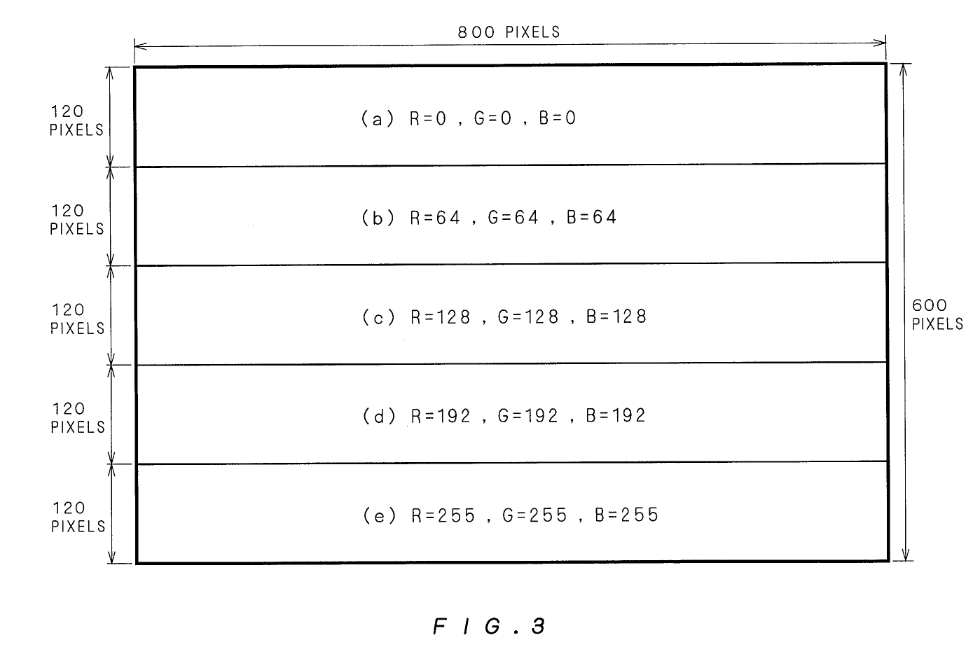

The adjusting-image data generated by the adjusting-image data generator 11 will be discussed below. FIG. 3 is a view showing an exemplary image on the basis of the adjusting-image data used for automatic level adjustment in the first preferred embodiment of the present invention. In this case, the general image data and the adjusting-image data each have 800 pixels laterally and 600 pixels vertically and each consist of three color data, i.e., R, G and B taking integers in a range from 0 to 255.

The image on the basis of the adjusting-image data is divided into five areas (a) to (e) each having 800 pixels laterally and 120 pixels vertically, as shown in FIG. 3. The image data in the area (a) has R=0, G=0 and B=0, the image data in the area (b) has R=64, G=64 and B=64, the image data in the area (c) has R=128, G=128 and B=128, the image data in the area (d) has R=192, G=192 and B=192, and the image data in the area (e) has R=255, G=255 and B=255.

It is assumed, in the image display system of the first preferred embodiment, that the adjusting-image data shown in FIG. 3 is outputted from the image data generation device 2b as the analog image data in performing the automatic level adjustment. Specifically, the automatic level adjuster 6b performs the automatic level adjustment on the basis of the adjusting-image data shown in FIG. 3. At that time, if in an ideal state without any effect of noise, the automatic level adjuster 6b can perform the maximum level adjustment and the minimum level adjustment in the following manner. First, the maximum level is adjusted to the maximum value within a range where there exist (800×120) pixels each having R=G=B=255 in one frame period of the digital image data into which the analog data of adjusting image is quantized by the A/D converter 5. On the other hand, the minimum level is adjusted to the minimum value within a range where there exist (800×120) pixels each having R=G=B=0 in one frame period of the digital image data into which the analog data of adjusting image is quantized by the A/D converter 5.

In other words, the automatic level adjuster 6b can perform an appropriate automatic level adjustment by providing the adjusting-image data with pixel data where the three color data of R, G and B take the maximum possible value and the minimum possible value, and the maximum level and the minimum level can be appropriately adjusted. It is thereby possible to achieve full tone reproduction in high luminance portions and low luminance portions of the image displayed on the display unit 4.

Further, when the three color data of R, G and B can be individually adjusted in level, by providing the adjusting-image data with pixel data where at least one color data to be adjusted in level takes the maximum possible value and the minimum possible value, the maximum level and the minimum level can be appropriately adjusted.

Furthermore, the image on the basis of the adjusting-image data (adjusting image) is not necessarily displayed on the whole screen and may be displayed only on part of the screen.

When some effect of noise should be considered, the maximum level adjustment and the minimum level adjustment are performed so that the number of pixels each having R=G=B=255 and the number of pixels each having R=G=B=0 may fall within predetermined limits, respectively. Further, when there are variations in level among the three color data of R, G and B, if the three color data of R, G and B can be individually adjusted in level, individual level adjustments are performed. For example, with respect to R, the maximum level adjustment and the minimum level adjustment are performed so that the number of pixels having R=255 and the number of pixels having R=0 may fall within predetermined limits. The same can be applied to G and B. On the other hand, if the three color data of R, G and B can not be individually adjusted in level, for example, the maximum level may be adjusted to the maximum value within a range where the number of pixels each having the minimum value not less than 248 among R, G and B is not less than a predetermined number, or the minimum level may be adjusted to the minimum value within a range where the number of pixels each having the maximum value not more than 8 among R, G and B is not less than a predetermined number.

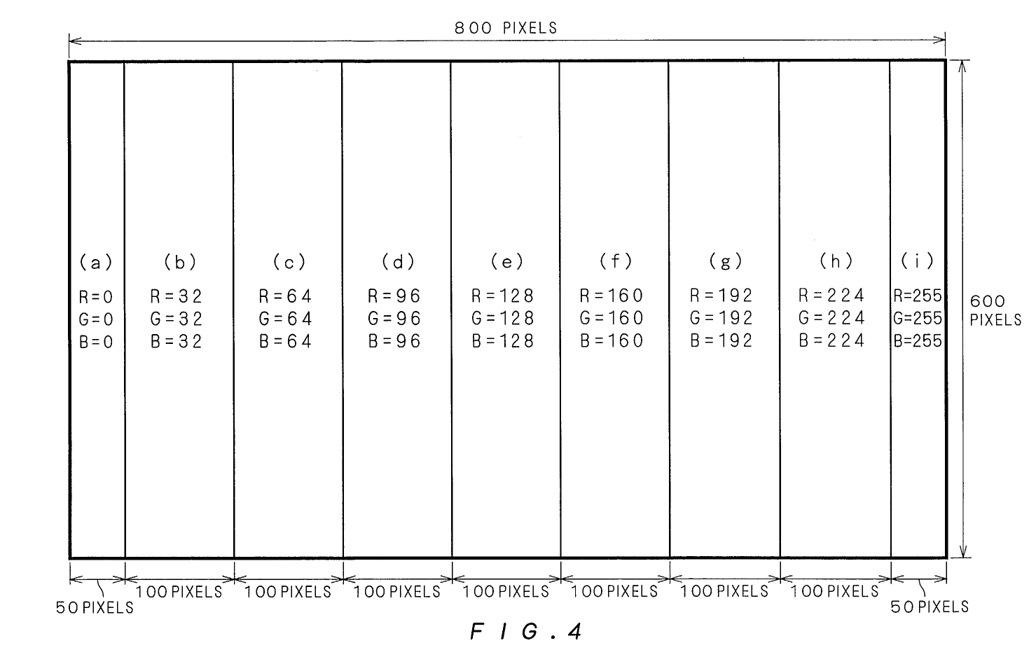

FIG. 4 is a view showing another exemplary image on the basis of the adjusting-image data. In this figure, the adjusting-image data has 800 pixels laterally and 600 pixels vertically, and is divided into two areas (a) and (i) each having 50 pixels laterally and 600 pixels vertically and five areas (b) to (h) each having 100 pixels laterally and 600 pixels vertically. The image data in the area (a) has R=0, G=0 and B=0, the image data in the area (b) has R=32, G=32 and B=32, the image data in the area (c) has R=64, G=64 and B=64, the image data in the area (d) has R=96, G=96 and B=96, the image data in the area (e) has R=128, G=128 and B=128, the image data in the area (f) has R=160, G=160 and B=160, the image data in the area (g) has R=192, G=192 and B=192, the image data in the area (h) has R=224, G=224 and B=224, and the image data in the area (i) has R=255, G=255 and B=255. It is assumed that the digital image data also ranges from 0 to 255. When the adjusting-image data shown in FIG. 4 is used, in the ideal state without any effect of noise, the maximum level is adjusted to the maximum value within a range where there exist (50×600) pixels each having R=G=B=255 in one frame period of the digital image data into which the analog data of adjusting image is quantized by the A/D converter 5. On the other hand, the minimum level is adjusted to the minimum value within a range where there exist (50×600) pixels each having R=G=B=0 in one frame period of the digital image data into which the analog data of adjusting image is quantized by the A/D converter 5.

Further, when the adjusting-image data shown in FIG. 4 is used, the maximum level adjustment and the minimum level adjustment can be performed by counting the number of occurrences of the maximum data and the minimum data in one line period, not in one frame period. Therefore, as compared with the case of using the adjusting-image data shown in FIG. 3, the automatic level adjustment can be completed in a shorter time.

Thus, in the method of automatically adjusting an image and the image display system of the first preferred embodiment, the automatic level adjustment in the image display device is always performed using the adjusting-image data suitable therefor. Therefore, it is possible to avoid the problem that the automatic image adjustment using the image not suitable therefor results in deterioration in quality of image. Further, an user has only to instruct to perform the automatic level adjustment and therefore can easily achieve an appropriate automatic level adjustment without any knowledge on the details of the automatic image adjustment to be performed.

Furthermore, since the automatic level adjustment is performed by optimizing the maximum level and the minimum level in quantization of the analog image data by the AID converter 5 in the first preferred embodiment, it is possible to prevent the number of valid bits of the digital image data which is an output from the A/D converter 5 from being reduced by the automatic level adjustment.

Though the timing of performing the automatic level adjustment is a timing that the user gives an instruction to perform the automatic level adjustment in the first preferred embodiment, the timing for the automatic level adjustment is not limited to this and the automatic level adjustment may be automatically started at a predetermined timing which is set in advance, not waiting for the user's instruction. As an example of the timing, the adjustment may be automatically started at power-on, at every timings of regular intervals, or the like.

Further, though the image adjustment performed in the image display device is the level adjustment (adjustment in luminance level) in the first preferred embodiment, application of the present invention is not limited to this level adjustment. Obviously, the present invention can be widely applied to image adjustments requiring image data suitable therefor, other than the level adjustment.

<The Second Preferred Embodiment>

In the first preferred embodiment, the automatic level adjustment is performed by inputting user's instruction to the image display device. The automatic level adjustment in the image display device, however, may be also performed by inputting user's instruction to the image data generation device.

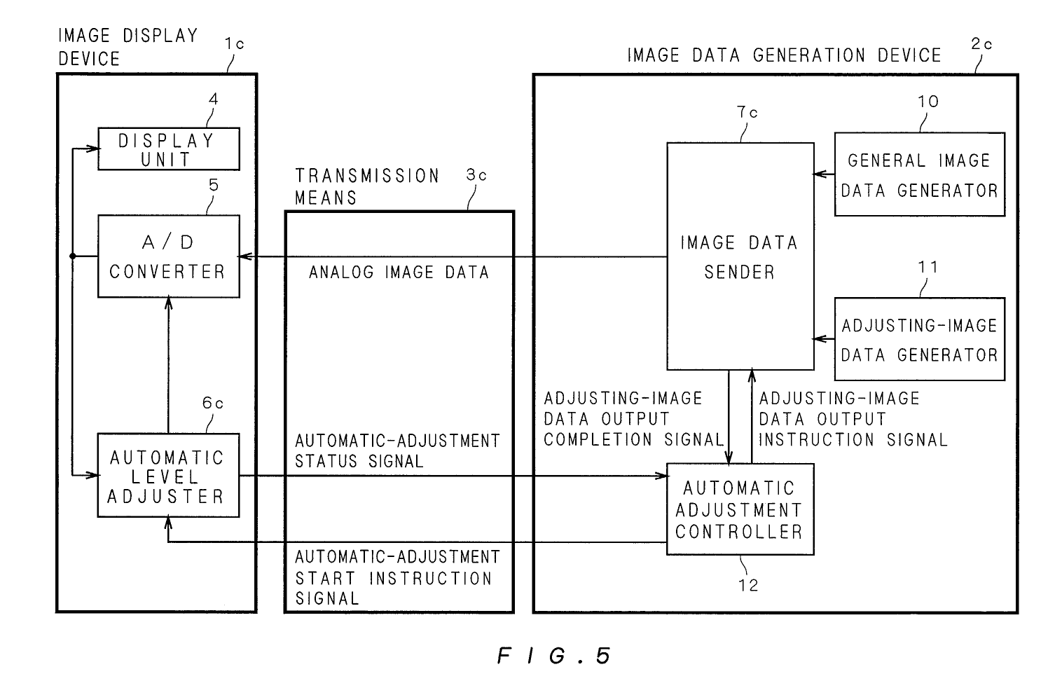

FIG. 5 is a block diagram showing an exemplary constitution of an image display system in accordance with the second preferred embodiment of the present invention. This figure shows an image display device 1c, an image data generation device 2c and transmission means 3c. Further, the image display device 1c has the display unit 4, the A/D converter 5 and an automatic level adjuster 6c. The image data generation device 2c has an image data sender 7c, a general image data generator 10, an adjusting-image data generator 11 and an automatic adjustment controller 12.

The transmission means 3c is used for data transmission between the image display device 1c and the image data generation device 2c.

It is assumed, in the second preferred embodiment, that an automatic level adjustment is performed in the image display device 1c at a timing that a user gives an instruction to perform the automatic level adjustment to the image data generation device 2c.

The general image data generator 10 in the image data generation device 2c generates general image data in a state of normal use and outputs the general image data to the image data sender 7c. On the other hand, the adjusting-image data generator 11 generates image data used for an image adjustment in the automatic level adjustment (referred to as “adjusting-image data”) and outputs the adjusting-image data to the image data sender 7c.

The image data sender 7c sends either the general image data or the adjusting-image data as the analog image data to the transmission means 3c on the basis of the content of an adjusting-image data output instruction signal from the automatic adjustment controller 12. Further, the image data sender 7c outputs an adjusting-image data output completion signal used for notifying whether an operation of outputting the adjusting-image data is completed or not, to the automatic adjustment controller 12. The content of the adjusting-image data output completion signal is controlled to be “OK” when the output operation of the adjusting-image data is completed and otherwise “NG”.

The automatic adjustment controller 12 instructs the image data sender 7c which data should be outputted, the general image data or the adjusting-image data, on the basis of the user's instruction and a signal (automatic-adjustment status signal) from the automatic level adjuster 6c. Specifically, the automatic adjustment controller 12 outputs the adjusting-image data output instruction signal of “ON” when the user instructs to perform the automatic level adjustment and outputs the adjusting-image data output instruction signal of “OFF” in the state of normal use. Further, the image data sender 7c sends the general image data to the transmission means 3c when the adjusting-image data output instruction signal indicates “OFF” and it sends the adjusting-image data thereto when the adjusting-image data output instruction signal indicates “ON”. Furthermore, the automatic adjustment controller 12 sends an automatic-adjustment start instruction signal used for instructing the automatic level adjuster 6c to start the automatic level adjustment on the basis of the adjusting-image data output completion signal from the image data sender 7c. Specifically, when the adjusting-image data output completion signal indicates “OK”, the automatic adjustment controller 12 sends the automatic-adjustment start instruction signal of “ON” to the automatic level adjuster 6c, thereby starting the automatic level adjustment. Otherwise the automatic-adjustment start instruction signal is controlled to be “OFF”.

The automatic level adjuster 6c controls the A/D converter 5 to perform the automatic level adjustment when the automatic-adjustment start instruction signal from the automatic adjustment controller 12 indicates “ON” and outputs the automatic-adjustment status signal for notifying an operating state of the automatic level adjuster 6c. The content of the automatic-adjustment status signal is controlled to be “Execution” when the automatic level adjuster 6c performs the automatic level adjustment and otherwise “Standby”. Further, the automatic adjustment controller 12 is controlled to change the content of the adjusting-image data output instruction signal to “OFF” when the automatic-adjustment status signal is changed from “Execution” to “Standby”.

An operation of the image display system of the second preferred embodiment will be discussed below.

First, an operation in the state of normal use will be discussed. In the state of normal use, since the adjusting-image data output instruction signal outputted from the automatic adjustment controller 12 indicates “OFF”, the image data sender 7c sends the general image data which is generated by the general image data generator 10 to the transmission means 3c as the analog image data. Further, at this time, since no adjusting-image data is sent out and the adjusting-image data output completion signal therefore indicates “NG”, the automatic-adjustment start instruction signal is controlled to be “OFF”.

Therefore, the automatic level adjuster 6c is in a standby state, not performing the automatic level adjustment, and the automatic-adjustment status signal indicates “Standby”.

The general image data outputted from the image data sender 7c is transmitted through the transmission means 3c and quantized into image data of digital signals (digital image data) in the A/ID converter 5 of the image display device 1c with reference to the reference voltage. The digital image data is inputted to the display unit 4 and displayed as an image.

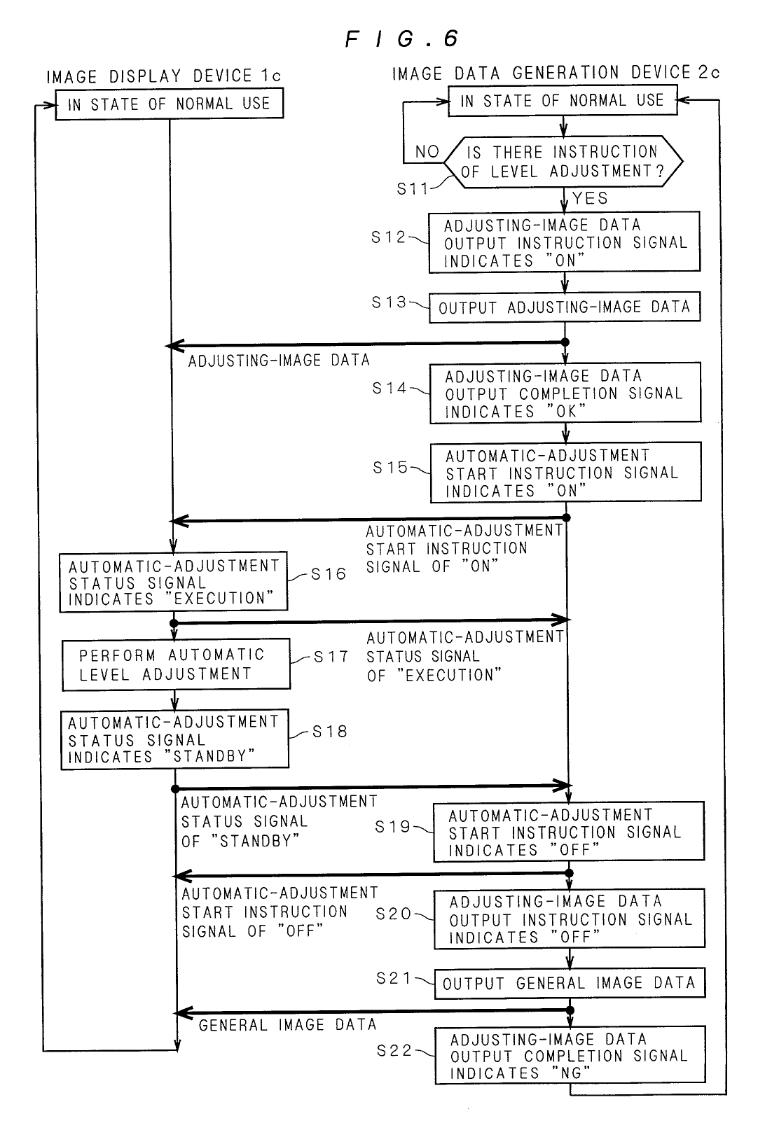

Next, an operation for performing the automatic level adjustment will be discussed. FIG. 6 is a view illustrating an operation for automatic level adjustment in the image display system in accordance with the second preferred embodiment of the present invention. Discussion will be made below, referring to FIGS. 5 and 6.

First, when the user gives the image data generation device 2c an instruction to perform the automatic level adjustment (Sll), the automatic adjustment controller 12 changes the content of the adjusting-image data output instruction signal from “OFF” to “ON” (S12).

The image data sender 7c sends the adjusting-image data which is generated by the adjusting-image data generator 11 to the transmission means 3c as the analog image data since the adjusting-image data output instruction signal indicates “ON” (S13). Further, when the adjusting-image data is completely sent out, the image data sender 7c sends the adjusting-image data output completion signal indicating “OK” to the automatic adjustment controller 12 (S14).

The automatic adjustment controller 12, receiving the adjusting-image data output completion signal of “OK”, sends the automatic-adjustment start instruction signal indicating “ON” to the transmission means 3c (S15).

The automatic-adjustment start instruction signal is inputted to the automatic level adjuster 6c of the image display device 1c through the transmission means 3c. The automatic level adjuster 6c, receiving the automatic-adjustment start instruction signal of “ON”, changes the content of the automatic-adjustment status signal to “Execution” (S16) and performs the automatic level adjustment (S17).

Then, when the level adjustment of the digital image data is completed, the automatic level adjuster 6c changes the content of the automatic-adjustment status signal to.“Standby” (S18). The automatic-adjustment status signal is inputted to the automatic adjustment controller 12 of the image data generation device 2c through the transmission means 3c. When the automatic-adjustment status signal indicates “Standby”, the automatic adjustment controller 12 changes the content of the automatic-adjustment start instruction signal to “OFF” (S19) and the content of the adjusting-image data output instruction signal to “OFF” (S20).

The image data sender 7c, receiving the adjusting-image data output instruction signal of “OFF”, outputs the general image data generated by the general image data generator 10 as the analog image data (S21). Furthermore, when the general image data is completely sent out, the image data sender 7c outputs the adjusting-image data output completion signal indicating “NG” (S22). In other words, both the image display device 1c and the image data generation device 2c return to the state of normal use.

Thus, in the method of automatically adjusting an image and the image display system of the second preferred embodiment, the automatic level adjustment in the image display device is always performed using the adjusting-image data suitable therefor. Therefore, it is possible to avoid the problem that the automatic image adjustment using the image not suitable therefor results in deterioration in quality of image. Further, an user has only to instruct to perform the automatic level adjustment and therefore can easily achieve an appropriate automatic level adjustment without any knowledge on the details of the automatic image adjustment to be performed.

Furthermore, since the automatic level adjustment is performed by optimizing the maximum level and the minimum level in quantization of the analog image data by the A/D converter 5 in the second preferred embodiment, it is possible to prevent the number of valid bits of the digital image data which is an output from the A/D converter 5 from being reduced by the automatic level adjustment.

Though the timing of performing the automatic level adjustment is a timing that the user gives an instruction to perform the automatic level adjustment in the second preferred embodiment, the timing for the automatic level adjustment is not limited to this and the automatic level adjustment may be automatically started at a predetermined timing which is set in advance, not waiting for the user's instruction.

Further, though the image adjustment performed in the image display device is the level adjustment (adjustment in luminance level) in the second preferred embodiment, application of the present invention is not limited to this level adjustment. Obviously, the present invention can be widely applied to image adjustments requiring image data suitable therefor, other than the level adjustment.

<The Third Preferred Embodiment>

In the first and second preferred embodiments, during the automatic level adjustment, the adjusting-image data representing an image suitable for the automatic level adjustment is inputted to the image display device as image data. In this case, the image (adjusting image) on the basis of the adjusting-image data is displayed on the display unit of the image display device during the automatic level adjustment in the systems having the constitutions shown in FIGS. 1 and 5.

The adjusting-image data used for the automatic level adjustment is often different from the image displayed in the state of normal use, like in the cases shown in FIGS. 3 and 4, and there is possibility that displaying the image on the basis of the adjusting-image data on the display unit 4 during the automatic level adjustment should confuse the user to think it is malfunction of the device. In particular, when the automatic level adjustment is automatically started at a predetermined timing, not at the timing of user's instruction, this becomes a great problem.

For example, it is assumed, in FIG. 1, that the image data generation device 2b is a personal computer and the image display device 1b is a liquid crystal display and when an image taken by e.g., a digital still camera is displayed on the liquid crystal display, an user is unsatisfied by the gradation of the image displayed on the liquid crystal display and specifies execution of the automatic level adjustment. The adjusting-image data displayed at this time is displayed on the liquid crystal display during execution of the automatic image adjustment. It is not necessarily easy for all users to associate execution of the automatic image adjustment with display of the adjusting image and there is possibility that many users having few knowledge on the operation of the automatic level adjustment and the adjusting-image data in the image display system may be confused.

As discussed above, the adjusting image is not necessarily displayed on the whole screen and may be displayed only in part of the image on the basis of the general image data. That alleviates this problem. Even if the adjusting image is part of the screen image, however, the fact remains that it is not necessarily easy for all users to associate execution of the automatic image adjustment with display of the adjusting image. Then, the third preferred embodiment proposes an image display system which would avoid such a confusion.

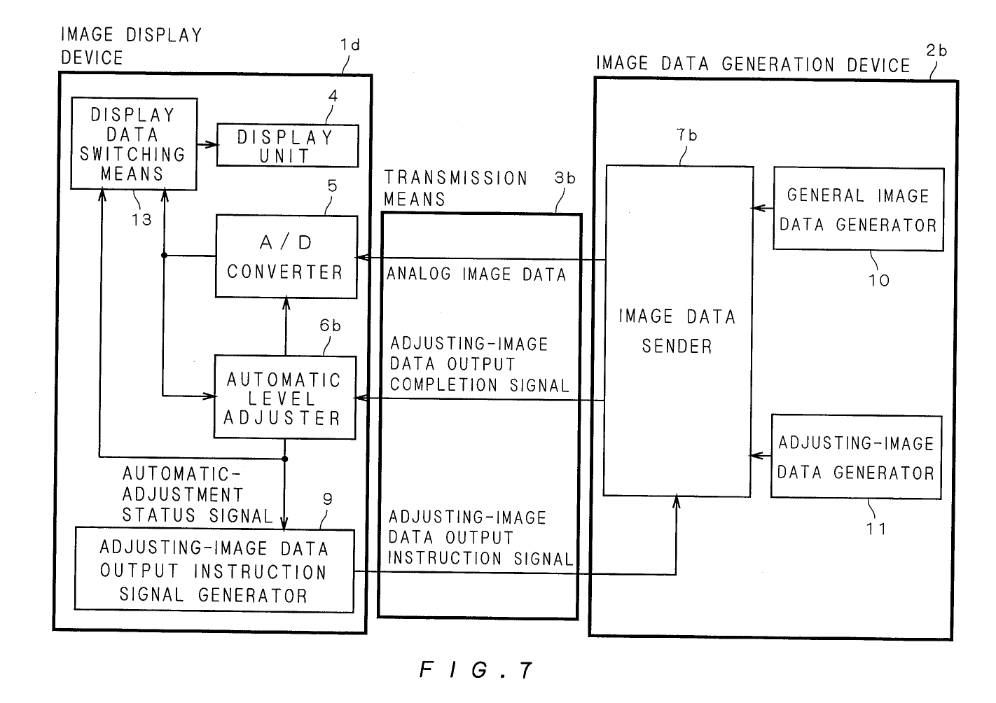

FIG. 7 is a block diagram showing an exemplary constitution of an image display system in accordance with the third preferred embodiment of the present invention. This figure shows an image display device id of the third preferred embodiment and display data switching means 13 included in the image display device id. Further, other constituent elements are identical to those in FIG. 1 represented by the same reference signs and detailed description will be herein omitted.

The display data switching means 13 receives the digital image data from the A/D converter 5 and the automatic-adjustment status signal from the automatic level adjuster 6b and switches the image data to be displayed on the display unit 4 between the digital image data from the A/D converter 5 and the during-adjustment image data on the basis of the automatic-adjustment status signal. The during-adjustment image data is image data generated by the display data switching means 13 to display an image for notifying the user that the automatic level adjustment is being performed. The display data switching means 13 outputs the digital image data from the A/D converter 5 to the display unit 4 when the automatic-adjustment status signal indicates “Standby” (i.e., in the state of normal use) and on the other hand, the means 13 generates the during-adjustment image data and outputs it to the display unit 4 when the automatic-adjustment status signal indicates “Execution” (i.e., under the automatic level adjustment).

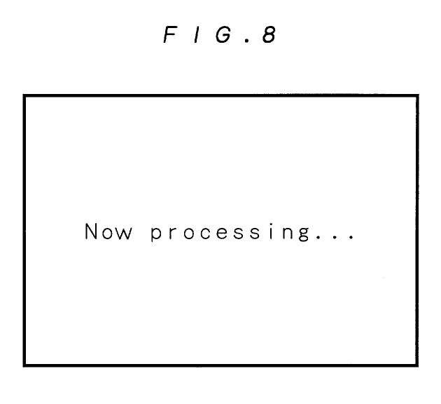

FIG. 8 is a view showing an exemplary image (under the adjustment) displayed on the display unit 4 on the basis of the during-adjustment image data. As shown in this figure, the image on the basis of the during-adjustment image data is such as allows the user to instantly understand that the automatic level adjustment is being performed in the image display device 1d.

Therefore, in the image display system of the third preferred embodiment, since a during-adjustment image is displayed during the automatic level adjustment, the user can recognize that the automatic image adjustment is being performed and it is thereby possible to avoid user's confusion.

Though herein discussed is the case where the automatic level adjustment is performed by inputting user's instruction to the image display device like in the first preferred embodiment, the third preferred embodiment can be easily applied to a case where the automatic level adjustment is performed by inputting user's instruction to the image data generation device like in the second preferred embodiment. For example, by providing the image display device 1c of FIG. 5 with the display data switching means which switches image data to be displayed on the display unit 4 on the basis of the automatic-adjustment status signal outputted from the automatic level adjuster 6c between the digital image data from the A/D converter 5 and the during-adjustment image data, the same effect can be obviously produced.

<The Fourth Preferred Embodiment>

In the above preferred embodiments, the automatic level adjustment is realized by optimizing the maximum level and the minimum level in quantization of the analog image data with the A/D converter 5. In contrast to this, an image adjustment can be also realized by digital computation on the image data digitized by the A/D converter 5.

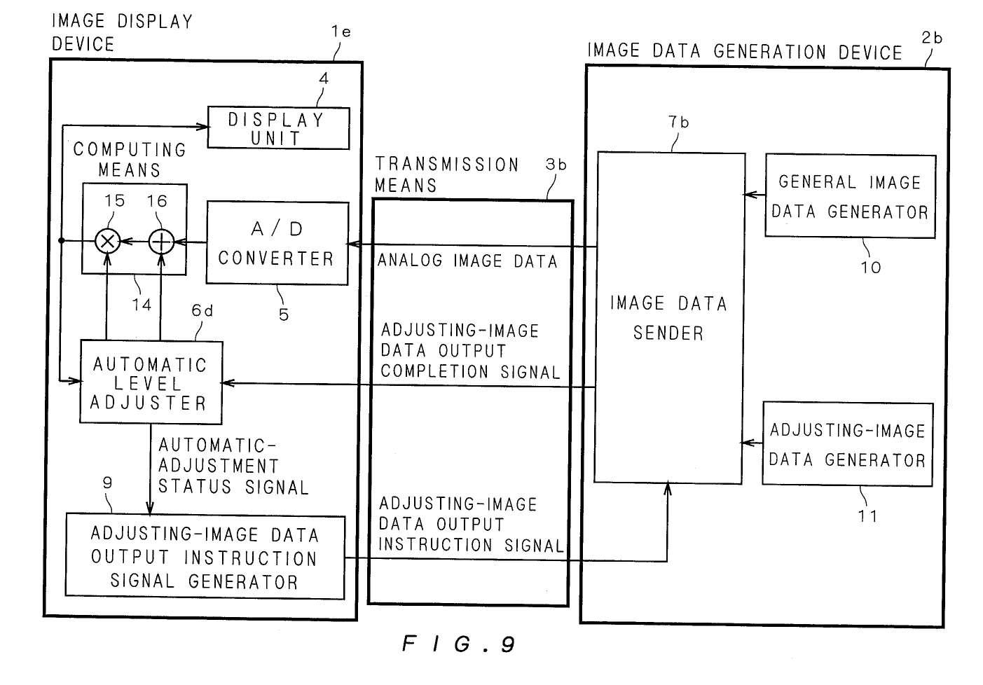

FIG. 9 is a block diagram showing an exemplary constitution of an image display system in accordance with the fourth preferred embodiment of the present invention. This figure shows an image display device 1e, an automatic level adjuster 6d and computing means 14. Further, the computing means 14 has a multiplier 15 and an adder 16. Furthermore, other constituent elements are identical to those in FIG. 1 represented by the same reference signs and detailed description will be herein omitted.

The computing means 14 receives the digital image data outputted from the A/D converter 5 and performs computation on the digital image data with the multiplier 15 and the adder and 16 to adjust the luminance level of the image. The adder 16 obtains image data by adding an offset value to the digital image data and outputs the image data to the multiplier 15. The multiplier 15 multiplies the image data from the adder 16 by multiplication coefficient and outputs the product as after-computation image data. The after-computation image data is inputted to the display unit 4 and the automatic level adjuster 6d.

Now, an operation of the automatic level adjuster 6d will be discussed. The automatic level adjuster 6d performs an automatic level adjustment to optimize the adjustment in luminance level of the digital image data in the computing means 14 by adjusting parameters (multiplication coefficient and offset value) for computation in the multiplier 15 and the adder 16 of the computing means 14.

The automatic level adjuster 6d receives the digital image data after computation by the computing means 14 (after-computation image data) and counts the number of occurrences of the maximum data and the minimum data in a predetermined period (e.g., one frame) of the after-computation image data. For example, assuming that the after-computation image data is 8-bit digital data having the minimum value of 0 and the maximum value of 255, the automatic level adjuster 6d counts the number of occurrences of data which takes 255 and the number of occurrences of data which takes 0 in a predetermined period. When the number of occurrences of the minimum data is less than a predetermined value, the automatic level adjuster 6d judges that the offset value to be outputted to the adder 16 is too large and outputs a reduced offset value. Further, when the number of occurrences of the minimum data is more than a predetermined value, the automatic level adjuster 6d judges that the offset value is too small and outputs an increased offset value.

Further, when the number of occurrences of the maximum data is less than a predetermined threshold value, the automatic level adjuster 6d judges that the multiplication coefficient to be outputted to the multiplier 15 is too small and outputs an increased multiplication coefficient. On the other hand, when the number of occurrences of the maximum data is more than a predetermined threshold value, the automatic level adjuster 6d judges that the multiplication coefficient is too large and outputs a reduced multiplication coefficient.

Thus, the computation is realized with one multiplier and one adder, and that has an advantage that a circuit design for the automatic level adjustment should become much easier.

Though herein discussed is the case where the offset value is added to the digital image data and then the sum is multiplied by the multiplication coefficient to realize the computation in the computing means 14, there may be a case where the digital image data is multiplied by the multiplication coefficient and then the offset value is added to the product, and obviously, the circuit design can also become much easier.

Further, the operations of other constituent elements shown in FIG. 9 are the same as discussed in the first preferred embodiment and so discussion will be herein omitted.

In the fourth preferred embodiment, since the image adjustment is performed by digital computation on the digital image data which is an output from the A/D converter 5, the automatic level adjustment can be performed by only digital signal processing and therefore the circuit design for automatic level adjustment advantageously becomes much easier.

Note, however, that there is possibility of reducing the number of valid bits of the digital image data which is an output from the A/D converter 5, depending on the analog image data to be inputted to the image display device 1e, since the reference voltage used in the A/D converter 5 is not controlled and takes a constant value.

Though herein discussed is the case where the automatic level adjustment is performed by inputting user's instruction to the image display device like in the first preferred embodiment, obviously, the fourth preferred embodiment can be also applied to a case where the automatic level adjustment is performed by inputting user's instruction to the image data generation device like in the second preferred embodiment and a case where the display data switching means is further provided like in the third preferred embodiment.

While the invention has been shown and described in detail, the foregoing description is in all aspects illustrative and not restrictive. It is therefore understood that numerous modifications and variations can be devised without departing from the scope of the invention.

What is claimed is:

1. An image display system comprising an image data generation device for outputting image data and an image display device for displaying an image on the basis of said image data, wherein
said image display device comprises an automatic image adjuster for performing an automatic adjustment of a display image on the basis of said image data,
said image data generation device comprises
adjusting-image data output means for outputting adjusting-image data used for said automatic adjustment as said image data; and
adjusting-image data output completion notifying means for outputting an output completion signal used for notifying completion of output of said adjusting-image data from said adjusting-image data output means, and
said automatic image adjuster receives said output completion signal and performs said automatic adjustment when notified of the completion of output of said adjusting-image data.

2. The image display system according to claim 1, wherein
said image display device further comprises automatic-adjustment start notifying means for outputting an adjustment start signal used for notifying a start of said automatic adjustment which is performed by said automatic image adjuster, and
said adjusting-image data output means receives said adjustment start signal and outputs said adjusting-image data as said image data when notified of the start of said automatic adjustment.

3. The image display system according to claim 1, wherein
said image display device further comprises during-adjustment image data output means for outputting during-adjustment image data used for notifying a user that said automatic adjustment is being performed and displays an image on the basis of said during-adjustment image data during execution of said automatic adjustment on the basis of said adjustment start signal.

4. The image display system according to claim 1, wherein
said image data outputted from said image data generation device is analog image data of analog signals,
said automatic adjustment performed by said automatic image adjuster is a level adjustment for adjusting luminance levels,
said image display device further comprises an A/D converter for converting said analog image data into digital image data of digital signals on the basis of a predetermined threshold voltage, and
said automatic image adjuster performs said level adjustment by controlling said threshold voltage.

5. The image display system according to claim 1, wherein
said image data outputted from said image data generation device is analog image data of analog signals,
said automatic adjustment performed by said automatic image adjuster is a level adjustment for adjusting luminance levels,
said image display device further comprises an A/D converter for converting said analog image data into digital image data of digital signals on the basis of a predetermined threshold voltage, and
said automatic image adjuster includes computing means for performing said level adjustment by computation on said digital image data.

6. The image display system according to claim 5, wherein
said computing means is constituted of a multiplier for multiplying said digital image data by a predetermined multiplication coefficient and an adder for adding a predetermined offset value to said digital image data which is multiplied by said multiplication coefficient in said multiplier, and
said automatic image adjuster performs said level adjustment by controlling said multiplication coefficient and said offset value.

7. The image display system according to claim 5, wherein
said computing means is constituted of an adder for adding a predetermined offset value to said digital image data and a multiplier for multiplying said digital image data to which said predetermined offset value is added by a predetermined multiplication coefficient, and
said automatic image adjuster performs said level adjustment by controlling said multiplication coefficient and said offset value.

8. The image display system according to claim 1, wherein
said image data outputted from said image data generation device is analog image data of analog signals,
said automatic adjustment performed by said automatic image adjuster is a level adjustment for adjusting luminance levels, and
said adjusting-image data is made of pixel data consisting of three color data, i.e., red, green and blue and at least one of said three color data takes the maximum possible value of said color data.

9. The image display system according to claim 1, wherein
said image data outputted from said image data generation device is analog image data of analog signals,
said automatic adjustment performed by said automatic image adjuster is a level adjustment for adjusting luminance levels, and
said adjusting-image data is made of pixel data consisting of three color data, i.e., red, green and blue and at least one of said three color data takes the minimum possible value of said color data.

10. A method of adjusting an image, being used in an image display system comprising an image data generation device for outputting image data and an image display device for displaying an image on the basis of said image data and performing an automatic adjustment of a display image on the basis of said image data, comprising the steps of:
(a) outputting adjusting-image data used for said automatic adjustment as said image data from said image data generation device to said image display device;
(b) outputting an output completion signal used for notifying completion of output of said adjusting-image data from said image data generation device to said image display device; and
(c) performing said automatic adjustment in said image display device when said image display device is notified of the completion of output of said adjusting-image data in said step (b).

11. The method of adjusting an image according to claim 10, further comprising the step of:
(d) outputting an adjustment start signal used for notifying a start of said automatic adjustment from said image display device to said image data generation device,
wherein said step (a) is executed when said image data generation device is notified of the start of said automatic adjustment in said step (d).

12. The method of adjusting an image according to claim 10, further comprising the step:
(e) generating during-adjustment image data used for notifying a user that said automatic adjustment is being performed and displaying an image on the basis of said during-adjustment image data in said image display device during said step (c).

13. The method of adjusting an image according to claim 10, wherein
said image data outputted from said image data generation device is analog image data of analog signals, and
said automatic adjustment performed in said step (c) is a level adjustment for adjusting luminance levels,
said method further comprising the step of:
(f) converting said analog image data into digital image data of digital signals on the basis of a predetermined threshold voltage in said image display device,
wherein said level adjustment in said step (c) is performed by controlling said threshold voltage.

14. The method of adjusting an image according to claim 10, wherein
said image data outputted from said image data generation device is analog image data of analog signals, and
said automatic adjustment performed in said step (c) is a level adjustment for adjusting luminance levels,
said method further comprising the step of:
(g) converting said analog image data into digital image data of digital signals on the basis of a predetermined threshold voltage in said image display device,
wherein said level adjustment in said step (c) is performed by computation on said digital image data.

15. The method of adjusting an image according to claim 14, wherein
said computation in said step (g) comprises the steps of:
(h) multiplying said digital image data by a predetermined multiplication coefficient; and
(i) adding a predetermined offset value to said digital image data which is multiplied by said multiplication coefficient in said step (h), and
said level adjustment in said step (c) is performed by controlling said multiplication coefficient and said offset value.

16. The method of adjusting an image according to claim 14, wherein
said computation in said step (g) comprises the steps of:
(j) adding a predetermined offset value to said digital image data; and
(k) multiplying said digital image data to which said predetermined offset value is added in said step 0) by a predetermined multiplication coefficient, and
said level adjustment in said step (c) is performed by controlling said multiplication coefficient and said offset value.

17. The method of adjusting an image according to claim 10, wherein
said image data outputted from said image data generation device is analog image data of analog signals,
said automatic adjustment performed in said step (c) is a level adjustment for adjusting luminance levels, and
said adjusting-image data is made of pixel data consisting of three color data, i.e., red, green and blue and at least one of said three color data takes the maximum possible value of said color data.

18. The method of adjusting an image according to claim 10, wherein
said image data outputted from said image data generation device is analog image data of analog signals,
said automatic adjustment performed in said step (c) is a level adjustment for adjusting luminance levels, and
said adjusting-image data is made of pixel data consisting of three color data, i.e., red, green and blue and at least one of said three color data takes the minimum possible value of said color data.

19. An image data generation device for outputting image data, comprising:
adjusting-image data output means for outputting adjusting-image data used for an automatic adjustment of a display image as said image data; and
adjusting-image data output completion notifying means for outputting an output completion signal used for notifying completion of output of said adjusting-image data from said adjusting-image data output means.

20. An image data generation device for outputting image data, comprising:
adjusting-image data output means for outputting adjusting-image data used for an automatic adjustment of a display image as said image data,
wherein said adjusting-image data output means outputs said adjusting-image data on the basis of a signal which is externally inputted.

21. The image data generation device according to claim 19, wherein
said adjusting-image data output means outputs said adjusting-image data on the basis of a signal which is externally inputted.

22. An image display device for displaying an image on the basis of image data, comprising:
automatic image adjuster for performing an automatic adjustment of a display image on the basis of said image data,
wherein said automatic image adjuster performs said automatic adjustment on the basis of a signal which is externally inputted.

23. An image display device for displaying an image on the basis of image data, comprising:
automatic image adjuster for performing an automatic adjustment of a display image on the basis of said image data; and
automatic-adjustment start notifying means for outputting an adjustment start signal used for notifying a start of said automatic adjustment which is performed by said automatic image adjuster.

24. The image display device according to claim 22, further comprising:
automatic-adjustment start notifying means for outputting an adjustment start signal used for notifying a start of said automatic adjustment which is performed by said automatic image adjuster.
